(19) United States
(12) Patent Application Publication
(10) Pub. No.: US 2025/0293892 A1
(43) Pub. Date: Sep. 18, 2025

(54) DATA PROCESSING METHOD AND APPARATUS, DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Yi WU, Shenzhen (CN)

(21) Appl. No.: 19/222,602

(22) Filed: May 29, 2025

Related U.S. Application Data
(63) Continuation of application No. PCT/CN2024/084133, filed on Mar. 27, 2024.

(30) Foreign Application Priority Data
May 8, 2023 (CN) 202310516610.6

(51) Int. Cl. H04L 9/32

(52) U.S. Cl. CPC H04L 9/3247

(57) ABSTRACT

A data processing method includes transmitting, at a moment, transaction data initiated by a service account to a core account layer. The transaction data includes a service transaction and a transaction verification time range corresponding to the service transaction, and the transaction data carries a data signature. The method further includes performing, in the core account layer, signature verification on the data signature, performing, in response to the signature verification being successful, legality verification on the service transaction according to the moment and the transaction verification time range, and associatively storing, in response to the service transaction being legal, the moment and the transaction data in a core account database corresponding to the core account layer.

### CROSS-REFERENCE TO RELATED APPLICATIONS

This application is a continuation of International Application No. PCT/CN2024/084133, filed on Mar. 27, 2024, which claims priority to Chinese Patent Application No. 2023105166106, filed with the China National Intellectual Property Administration on May 8, 2023 and entitled “DATA PROCESSING METHOD AND APPARATUS, DEVICE, AND COMPUTER-READABLE STORAGE MEDIUM,” the entire contents of both of which are incorporated herein by reference.

### FIELD OF THE TECHNOLOGY

This application relates to the field of Internet technologies, and in particular, to a data processing method and apparatus, a device, and a computer-readable storage medium.

### BACKGROUND OF THE DISCLOSURE

In today's era of information and electronic service systems, security of service accounts has become one of key protections for various service institutions.

In the related art, a service institution generally completes transaction password verification or signature verification of a service account by using a transaction layer or a service layer, and then the transaction layer or the service layer transmits a resource transfer-out instruction for the service transaction to a core account layer. Since the resource transfer-out instruction transmitted by the transaction layer or the service layer is trusted, the core account layer performs resource transfer-out processing. It is clear that, in the related art, verification of transaction legality and resource transfer-out processing of the service account are independent of each other, which may lead to a potential security risk of the service account, such as a scenario, in which a service institution or an illegal person modifies account data of the service account or performs resource transfer-out processing without obtaining authorization of the service account. Therefore, security of the service account is reduced in the related art. In addition, in the related art, during subsequent transaction verification, all transactions of the service account need to be verified, resulting in a lengthy evidencing chain and low verification efficiency and accuracy.

### SUMMARY

In accordance with the disclosure, there is provided a data processing method including transmitting, at a moment, transaction data initiated by a service account to a core account layer. The transaction data includes a service transaction and a transaction verification time range corresponding to the service transaction, and the transaction data carries a data signature. The method further includes performing, in the core account layer, signature verification on the data signature, performing, in response to the signature verification being successful, legality verification on the service transaction according to the moment and the transaction verification time range, and associatively storing, in response to the service transaction being legal, the moment and the transaction data in a core account database corresponding to the core account layer.

Also in accordance with the disclosure, there is provided a data processing method including generating a transaction obtaining request for a service account according to a transaction verification request, and transmitting the transaction obtaining request to a service server, to cause the service server to obtain, according to the transaction obtaining request, target data of the service account from a core account database corresponding to a core account layer. The target data includes transaction data initiated by the service account, the transaction data includes a service transaction and a transaction verification time range corresponding to the service transaction, and the transaction verification time range is configured for instructing the service server to verify legality of the service transaction. The method further includes obtaining the target data returned by the service server, determining that the transaction data is illegal in response to the target data not including a data signature of the transaction data, and verifying legality of the transaction data according to the data signature in response to the target data including the data signature.

Also in accordance with the disclosure, there is provided a data processing method including determining, in a service account in response to a completion operation on a service transaction, a transaction verification time range configured for verifying legality of the service transaction, and generating a data signature of transaction data. The transaction data includes the service transaction and the transaction verification time range. The method further includes transmitting the transaction data carrying the data signature to a service server using the service account, to cause the service server to transmit, at a moment, the transaction data to a core account layer that is configured to perform signature verification processing on the data signature to obtain a signature verification result that includes a signature verification success result. The signature verification result is configured for instructing the core account layer to perform legality verification on the service transaction according to the moment and the transaction verification time range to obtain a verification result that includes a verification result indicating legality. The verification result indicating legality is configured for instructing the core account layer to associatively store the moment and the transaction data in a core account database for being transmitted to a verification device, for the verification device to verify legality of the transaction data according to the data signature.

### BRIEF DESCRIPTION OF THE DRAWINGS

FIG. 1 is a schematic diagram of a system architecture according to an embodiment of this application.

FIG. 2 is a schematic flowchart of a data processing method according to an embodiment of this application.

FIG. 3 is a schematic diagram showing a data processing scenario according to an embodiment of this application.

FIG. 4 is another schematic diagram showing a data processing scenario according to an embodiment of this application.

FIG. 5 is a schematic another flowchart of a data processing method according to an embodiment of this application.

FIG. 6 is a schematic interaction diagram of a data processing method according to an embodiment of this application.

FIG. 7 is a schematic another flowchart of a data processing method according to an embodiment of this application.

FIG. 8 is a schematic another flowchart of a data processing method according to an embodiment of this application.

FIG. 9 is another schematic flowchart of a data processing method according to an embodiment of this application.

FIG. 10 is another schematic interaction diagram of a data processing method according to an embodiment of this application.

FIG. 11 is a schematic structural diagram of a data processing apparatus according to an embodiment of this application.

FIG. 12 is another schematic structural diagram of a data processing apparatus according to an embodiment of this application.

FIG. 13 is another schematic structural diagram of a data processing apparatus according to an embodiment of this application.

FIG. 14 is a schematic structural diagram of a computer device according to embodiments of this application.

### DESCRIPTION OF EMBODIMENTS

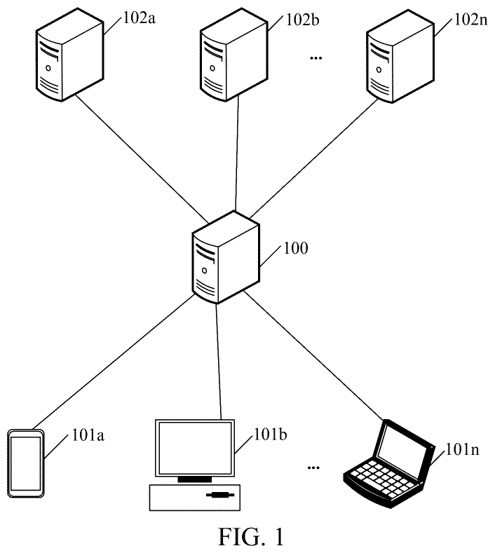

Referring to FIG. 1, FIG. 1 is a schematic diagram of a system architecture according to an embodiment of this application. As shown in FIG. 1, the system architecture may include a service server 100, a verification device cluster, and a terminal device cluster. The terminal device cluster may include one or more terminal devices. A quantity of the terminal devices is not limited in this application. As shown in FIG. 1, the terminal device cluster may include: a terminal device 101a, a terminal device 101b, . . . , and a terminal device 101n. Each terminal device in the terminal device cluster may include: an intelligent terminal with a transaction data transmission function such as a smartphone, a tablet computer, a notebook computer, a desktop computer, a smart speaker, a smartwatch, an in-vehicle terminal, or a smart television.

An application client may be installed on each terminal device in the terminal device cluster shown in FIG. 1. When the application client runs in each terminal device, data interaction may be separately performed with the service server 100 shown in FIG. 1. The application client may be an application client with a service account binding function such as a video application, a convenient life application, a payment application, a financial management application, a game application, a shopping application, a novel application, or a browser. The application client may be an independent client, or an embedded sub-client integrated in a client (such as a payment client, an education client, or a multimedia client), which is not limited herein.

In this embodiment of this application, the service server 100 may be a server corresponding to the foregoing application client. In an example in which the application client is a payment application, the service server 100 may be a set of a plurality of servers, such as a backend server and a data processing server that correspond to the payment application. Therefore, each terminal device may transmit data to the service server 100 by using the application client corresponding to the payment application. For example, each terminal device may transmit, by using the application client of the payment application, locally generated transaction data for a service account to the service server 100 at a second moment. The service server 100 may transmit the transaction data to a core account layer at a first moment. The core account layer verifies the transaction data, executes the transaction data after the verification succeeds, to obtain a transaction execution result, returns the transaction execution result to the terminal device, and associatively stores the first moment and the transaction data in a core account database. The service server 100 may be an independent physical server, or may be a server cluster or a distributed system including a plurality of physical servers, or may be a cloud server that provides a cloud computing service.

The verification device cluster may include one or more verification devices. A quantity of the verification devices is not limited in this application. As shown in FIG. 1, the verification device cluster may include: a verification device 102a, a verification device 102b, . . . , and a verification device 102n. Each verification device in the verification device cluster has a function of verifying the transaction data stored in the core account database by the service server 100. The function may be provided by a verification application. The verification application may be an application with a transaction data verification function, such as a video application, a convenient life application, a payment application, a financial management application, a game application, a shopping application, a novel application, or a browser. An application client corresponding to the verification application may be an independent client, or an embedded sub-client integrated in a client (such as a financial management client, an education client, or a multimedia client), which is not limited herein.

Each verification device in the verification device cluster in FIG. 1 includes, but is not limited to, a terminal device or a service server. The service server may be an independent physical server, or may be a server cluster or a distributed system including a plurality of physical servers, or may be a cloud server providing a basic cloud computing service, such as a cloud database, a cloud service, cloud computing, a cloud function, cloud storage, a network service, cloud communication, a middleware service, a domain name service, a security service, a content delivery network (CDN), big data, and an artificial intelligence platform. The terminal device includes, but is not limited to, a mobile phone, a computer, an intelligent voice interaction device, an intelligent household appliance, an in-vehicle terminal, an aircraft, and the like.

Communication connections may exist between the terminal device cluster. For example, a communication connection exists between the terminal device 101a and the terminal device 101b, and a communication connection exists between the terminal device 101a and the terminal device 101n. At the same time, any terminal device in the terminal device cluster may have a communication connection with the service server 100. For example, a communication connection exists between the terminal device 101a and the service server 100. At the same time, any terminal device in the terminal device cluster may have a communication connection with any verification device in the verification device cluster. For example, a communication connection exists between the terminal device 101a and the verification device 102a, and a communication connection exists between the terminal device 101b and the verification device 102a.

Any verification device in the verification device cluster may have a communication connection with the service server 100. For example, a communication connection exists between the verification device 102a and the service server 100. At the same time, communication connections may exist between the verification device cluster. For example, a communication connection exists between the verification device 102a and the verification device 102b.

A connection manner of all the communication connections described above is not limited in this application, which may be a direct or indirect connection through wired communication, or a direct or indirect connection through wireless communication, or connections in other manners.

During example application of collection and processing of relevant data (e.g., transaction data) in this application, informed consent or individual consent of a personal information subject needs to be obtained in strict accordance with requirements of relevant national laws and regulations, and subsequent data use and processing behaviors are carried out within the scope of authorization of laws and regulations and the personal information subject.

For ease of subsequent understanding and description, in this embodiment of this application, one terminal device may be selected from the terminal device cluster shown in FIG. 1 for illustration. For example, the terminal device 101a is illustrated. When responding to a completion operation on a service transaction for the service account at the second moment, the terminal device 101a may determine a transaction verification time range configured for verifying legality of the service transaction, determine the transaction verification time range and the service transaction as transaction data, perform signature processing on the transaction data by using a service private key of the service account, to obtain a data signature, and transmit the transaction data carrying the data signature to the service server 100. Specific content of the service transaction is not limited in this embodiment of this application, which includes, but is not limited to, a service transaction of a bank institution, a service transaction of a financial institution, and the like. At a first moment later than the second moment, the service server 100 obtains the transaction data transmitted by the terminal device 101a, and the service server 100 synchronously transmits the transaction data carrying the data signature to the core account layer. A moment at which the terminal device 101a determines the transaction verification time range is very close to a moment at which the data signature is generated. Therefore, in this embodiment of this application, the two very close moments are both referred to as the second moment. Similarly, a moment at which the service server 100 obtains the transaction data transmitted by the terminal device 101a is very close to a moment at which the service server 100 transmits the obtained transaction data to the core account database. Therefore, in this embodiment of this application, the two very close moments are both referred to as the first moment.

Further, in the core account layer, the service server 100 may perform signature verification processing on the data signature, to obtain a signature verification result, and if the signature verification result is a signature verification success result, perform legality verification on the service transaction according to the first moment and the transaction verification time range, to obtain a verification result. Further, if the verification result indicates that the service transaction is legal, the service server 100 associatively stores the first moment and the transaction data that carries the data signature in a core account database corresponding to the core account layer. The data signature and the transaction data that are stored in the core account database are both configured for being transmitted to a verification device (e.g., the verification device 102a in FIG. 1). The verification device is configured to verify legality of the transaction data according to the data signature. The service account is provided by the service server 100. In this embodiment of this application, the service account refers to a tool configured for managing digital resources, which may implement resource transfer of digital resources in an online transaction or an offline transaction. The service account is not limited in this embodiment of this application provided that the service account has a transaction function.

The service server 100, the terminal device 101a, the terminal device 101b, . . . , the terminal device 101n, the verification device 102a, the verification device 102b, . . . , and the verification device 102n above may all be blockchain nodes in a blockchain network. The data (e.g., the first moment and the transaction data) described throughout the specification may be stored in a manner that the blockchain nodes generate blocks according to the data and add the blocks to a blockchain for storage.

The blockchain is a new application mode of computer technologies such as distributed data storage, point-to-point transmission, a consensus mechanism, and an encryption algorithm, and is mainly configured to sort data in chronological order and encrypt the data into a ledger so that the data cannot be tampered with and forged and the data can be verified, stored, and updated. The blockchain is essentially a decentralized database. Each node in the database stores an identical blockchain, and the node is classified as a core node, a data node, and a light node in the blockchain network. The core node, the data node, and the light node jointly form a blockchain node. The core node is responsible for consensus of the entire blockchain network. That is, the core node is a consensus node in the blockchain network. A process in which the transaction data in the blockchain network is written to the ledger may be as follows: the data node or the light node in the blockchain network obtains to-be-chained data, and transmits the to-be-chained data in the blockchain network (that is, the nodes transmit the to-be-chained data in a relay baton manner) until the consensus node receives the to-be-chained data, and the consensus node packages the to-be-chained data into a block, performs a consensus on the block, and writes the to-be-chained data to the ledger after the consensus is completed. Herein, the to-be-chained data is illustrated with the first moment and the transaction data. The service server 100 (the blockchain node), after performing a consensus on the to-be-chained data, generates a block according to the to-be-chained data, and stores the block in the blockchain network. For reading of chained data (e.g., the first moment and the transaction data), the block including the chained data may be obtained by the blockchain node from the blockchain network, and further, the chained data is obtained from the block.

The method provided in this embodiment of this application may be performed by a computer device, and the computer device includes, but is not limited to, the terminal device, the service server, or the verification device. The terminal device, the service server, or the verification device may be connected directly or indirectly in a wired or wireless manner, which is not limited in this embodiment of this application.

The foregoing system architecture is applicable to a resource transfer query scenario and a resource transfer verification scenario, or is applicable to service scenarios such as an account state query scenario, an account state identification scenario, and an account state analysis scenario. Specific service scenarios are not listed one by one herein.

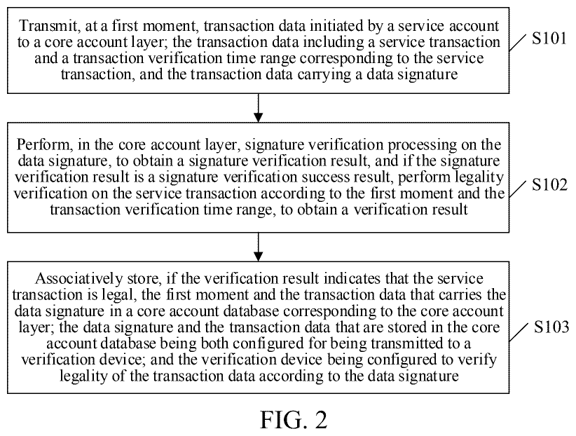

Further, referring to FIG. 2, FIG. 2 is a schematic flowchart of a data processing method according to an embodiment of this application. This embodiment of this application is applicable to various scenarios, including, but not limited to, a cloud technology, artificial intelligence, smart transportation, assisted driving, and the like. The data processing method may be performed by a service server (e.g., the service server 100 shown in FIG. 1), may be performed by a terminal device (that is, a service terminal such as the terminal device 101a shown in FIG. 1), may be performed by a verification device (e.g., the verification device 102a shown in FIG. 1), or may be interactively performed by at least two of the service server, the terminal device, and the verification device, which is not limited herein. For ease of understanding, this embodiment of this application is described with an example in which the method is performed by the service server. As shown in FIG. 2, the data processing method may include at least operation S101 to operation S103 below.

Operation S101: Transmit, at a first moment, transaction data initiated by a service account to a core account layer; the transaction data including a service transaction and a transaction verification time range corresponding to the service transaction, and the transaction data carrying a data signature.

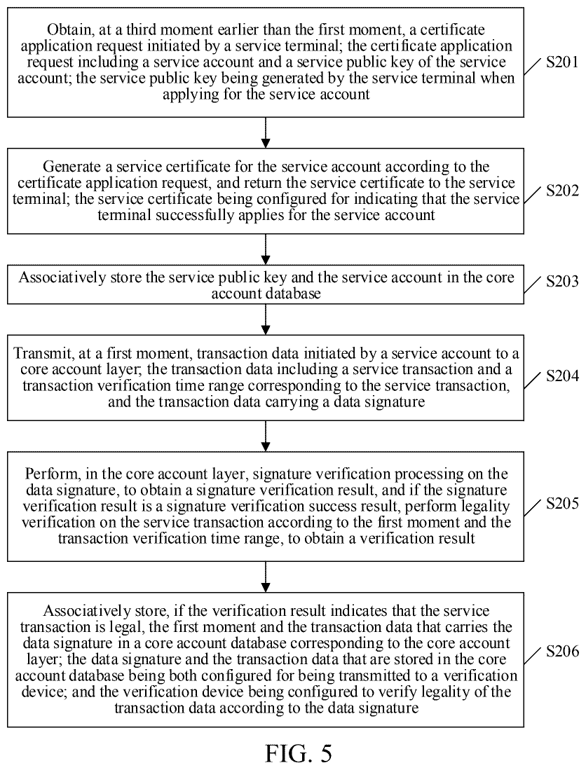

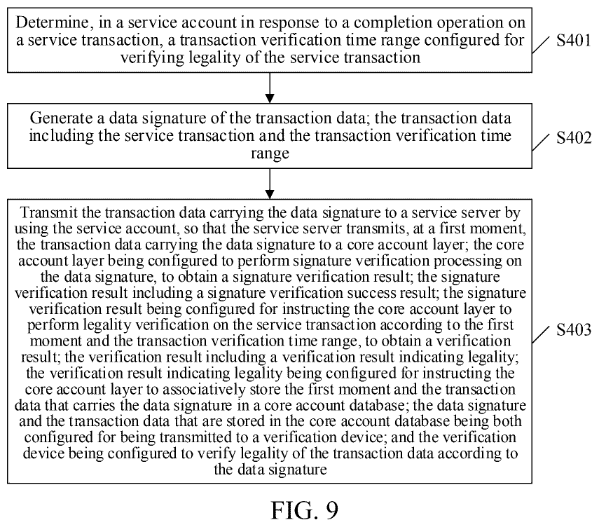

Specifically, a process in which a terminal device bound to the service account generates the transaction data is not described in detail in this embodiment of this application, which may be obtained with reference to the following description in the embodiment corresponding to FIG. 5 or FIG. 9.

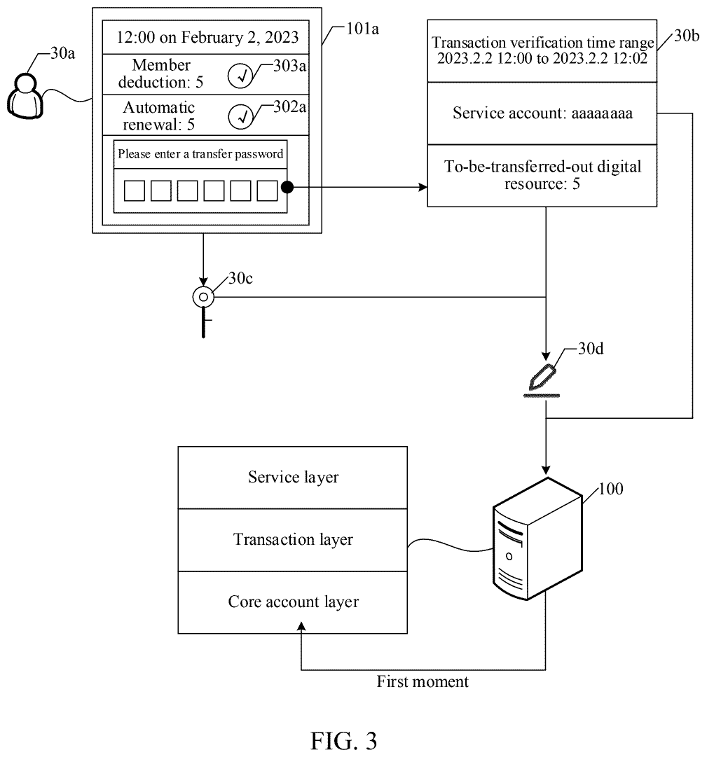

In a service information system (e.g., a financial information system), multi-level designs such as a service layer, an order layer, and a core account layer may exist. Referring to FIG. 3 together, FIG. 3 is a schematic diagram showing a data processing scenario according to an embodiment of this application. As shown in FIG. 3, the service server 100 includes a service layer, a transaction layer, and a core account layer. The core account layer is located at a bottom-layer module, and carries real resource data of the service account. Each resource transfer record of the core account layer represents a real resource change in the service account. The core account layer is mainly configured to carry a real resource stream of the service account. Main key information of the core account database of the core account layer includes the service account, a transaction occurrence amount, an account balance, a transaction time, a transaction type (transfer out, transfer in, or the like), a database signature, and the like.

This embodiment of this application is based on a solution of a zero-trust idea. The zero-trust idea is mainly a method for designing a system based on an assumption that module units (for example, the service layer, the transaction layer, and the core account layer in FIG. 3) of an information system do not trust each other. In the present disclosure, resource transfer at the core account layer does not rely on trust at an upper layer. Therefore, when obtaining, at the first moment, transaction data 30b transmitted by the terminal device 101a and carrying a data signature 30d, the service server 100 may synchronously transmit, to the core account layer, the data signature 30d and the transaction data 30b that are obtained.

Real-time nature of the service transaction is not limited in this embodiment of this application, which may be a real-time service transaction. For example, a service transaction in the transaction data 30b shown in FIG. 3 is a real-time service transaction. For example, when a service object 30a triggers a selection control 303a and enters a correct resource transfer password at 12:00 on Feb. 2, 2023, the terminal device 101a responds to an entering operation for the resource transfer password, and generates a real-time service transaction when verifying that the resource transfer password is a correct resource transfer password. The service transaction in this embodiment of this application may alternatively be a non-real-time service transaction. As shown in FIG. 3, the service object 30a triggers the selection control 302a, that is, the service object 30a selects automatic renewal. Then, when verifying that the resource transfer password is a correct resource transfer password, the terminal device 101a may generate a non-real-time service transaction. For example, 9:00 on Mar. 2, 2023 is set as a completion moment of the non-real-time service transaction, that is, the following second moment. As can be seen from the above, the determination of the second moment is not fixed, which may be set according to an actual application scenario.

Referring to FIG. 3 again, the transaction data 30b includes a transaction verification time range, that is, 12:00 on Feb. 2, 2023 to 12:02 on Feb. 2, 2023 in FIG. 3, and further includes a service transaction, that is, a service account (aaaaaaaa illustrated in FIG. 3) and a to-be-transferred-out digital resource (illustrated with 5 in FIG. 3) in FIG. 3. The transaction verification time range is a time range configured for verifying legality of the service transaction, and is different from a time range displayed by the terminal device 101a and prompting the service object 30a to enter the resource transfer password.

The interfaces and the controls shown in FIG. 3 are merely some representation forms for reference. In an actual service scenario, a developer may perform a related design according to a product requirement. Specific forms of the related interfaces and controls are not limited in this embodiment of this application.

Operation S102: Perform, in the core account layer, signature verification processing on the data signature, to obtain a signature verification result, and if the signature verification result is a signature verification success result, perform legality verification on the service transaction according to the first moment and the transaction verification time range, to obtain a verification result.

Specifically, in the core account database, a service public key of the service account is obtained, and signature verification processing is performed on the data signature by using the service public key, to obtain a first digital digest; a second digital digest of the transaction data is generated, and the first digital digest is compared with the second digital digest, to obtain a comparison result; the signature verification success result is determined as the signature verification result if the comparison result indicates that the first digital digest is the same as the second digital digest; the signature verification success result is further configured for indicating that the data signature is obtained by a service terminal bound to the service account by performing signature processing on the transaction data by using a service private key of the service account; and a signature verification failure result is determined as the signature verification result if the comparison result indicates that the first digital digest is different from the second digital digest.

Specifically, a relationship between the first moment and the transaction verification time range is identified; an earliest moment of the transaction verification time range is equal to a second moment at which the service terminal bound to the service account responds to a completion operation on the service transaction; and a latest moment of the transaction verification time range is later than the second moment; if the relationship between the first moment and the transaction verification time range is that the first moment is within the transaction verification time range, a verification result indicating legality is determined as a verification result of legality verification on the service transaction; the verification result indicating legality is configured for indicating that the service transaction is legal; if the relationship between the first moment and the transaction verification time range is that the first moment is later than the latest moment, a verification result indicating illegality is determined as a verification result of legality verification on the service transaction; and the verification result indicating illegality is configured for indicating that the service transaction is illegal.

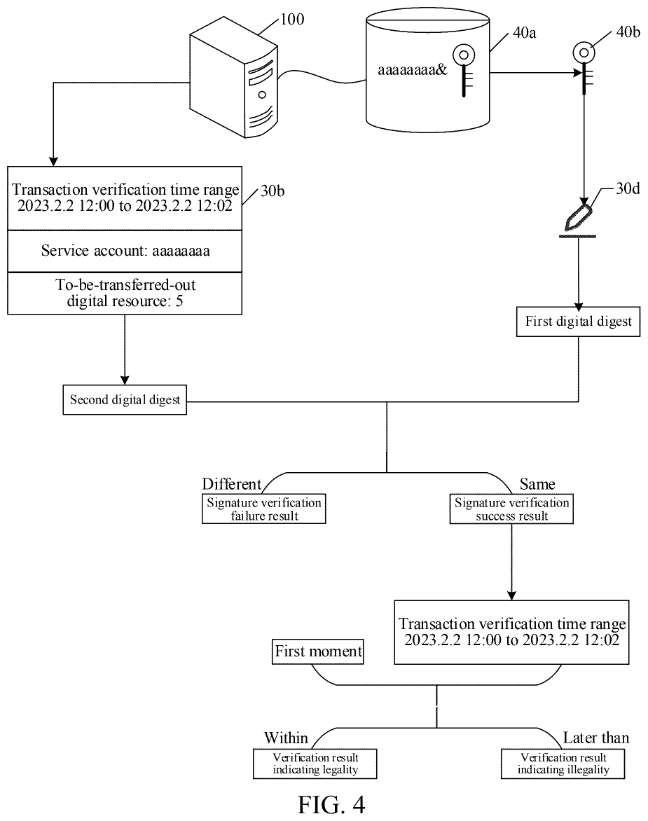

If the transaction data received by the core account layer does not carry the data signature, the core account layer may determine that the transaction data is illegal transaction data, and then this operation and subsequent operations are not performed. If the transaction data received by the core account layer carries the data signature, referring to FIG. 4 together, FIG. 4 is another schematic diagram showing a data processing scenario according to an embodiment of this application. As shown in FIG. 4, the service server 100 obtains, from a core account database 40a corresponding to the core account layer, a service public key 40b associatively stored with the service account. The service account is illustrated with aaaaaaaa in FIG. 4.

Further, in the core account layer, the service server 100 may perform, by using the service public key 40b, signature verification processing on the data signature 30d carried in the transaction data 30b, to obtain the first digital digest. At the same time, the service server 100 may generate the second digital digest of the transaction data 30b in the core account layer. The first digital digest and the second digital digest are each a string of hash values. The service server 100 may compare the first digital digest with the second digital digest, to obtain a comparison result; and the signature verification success result may be determined as the signature verification result if the comparison result indicates that the first digital digest is the same as the second digital digest. The signature verification success result may indicate that the data signature 30d is obtained by a service terminal bound to the service account (e.g., the terminal device 101a in FIG. 3) by performing signature processing on the transaction data 30b by using a service private key of the service account (e.g., the service private key 30c shown in FIG. 3). The service private key and the service public key are a pair of asymmetric keys, the service private key is not made public and is locally stored and used in the service terminal, and the service public key is made public. If the comparison result indicates that the first digital digest is different from the second digital digest, the service server 100 may determine the signature verification failure result as the signature verification result. The signature verification failure result may indicate that the transaction data 30b is a piece of illegal transaction data. Therefore, a subsequent process does not need to be performed, and the transaction is stopped.

Further, if the signature verification result of the data signature 30d is a signature verification success result, the service server 100 identifies a relationship between the first moment and the transaction verification time range. The earliest moment of the transaction verification time range is equal to the second moment at which the service terminal bound to the service account responds to the completion operation on the service transaction, and the latest moment of the transaction verification time range is later than the second moment. According to the descriptions of FIG. 3 and operation S101, in this embodiment of this application, the second moment is illustrated with 2023.2.2 12:00, and a duration of the transaction verification time range may be set according to a requirement of an actual application scenario, which is not limited in this embodiment of this application but is not excessively long in order to ensure security of the transaction data. In this embodiment of this application, the duration of the transaction verification time range is set to 2 minutes. That is, the transaction verification time range is illustrated as 2023.2.2 12:00 to 2023.2.2 12:02.

Further, if the relationship between the first moment and the transaction verification time range is that the first moment is within the transaction verification time range, the service server 100 may determine a verification result indicating legality as a verification result of legality verification on the service transaction. The verification result indicating legality is configured for indicating that the service transaction is legal. For example, the first moment is 2023.2. 2 12:00:05. It is clear that the first moment falls within the transaction verification time range illustrated in FIG. 4. If the relationship between the first moment and the transaction verification time range is that the first moment is later than the latest moment, the service server 100 may determine a verification result indicating illegality as a verification result of legality verification on the service transaction. The verification result indicating illegality is configured for indicating that the service transaction is illegal. For example, the first moment is 2023.2.2 12:05. It is clear that the first moment is later than the latest moment in the transaction verification time range illustrated in FIG. 4, i.e., 2023.2.2 12:02.

Operation S103: Associatively store, if the verification result indicates that the service transaction is legal, the first moment and the transaction data that carries the data signature in a core account database corresponding to the core account layer; the data signature and the transaction data that are stored in the core account database being both configured for being transmitted to a verification device; and the verification device being configured to verify legality of the transaction data according to the data signature.

Specifically, a current digital resource of the service account is obtained from the core account database corresponding to the core account layer; a resource transfer value in the service transaction is obtained, and if the current digital resource includes a to-be-transferred digital resource (also referred to as “candidate digital resource”) corresponding to the resource transfer value, resource transfer processing is performed on the to-be-transferred digital resource in the current digital resource, and a current digital resource after the resource transfer processing is determined as an updated digital resource; and the first moment, the updated digital resource, and the transaction data that carries the data signature are associatively stored in the core account database.

If the verification result indicates that the service transaction is illegal, the service server does not perform this operation. If the verification result indicates that the service transaction is legal, the current digital resource of the service account is obtained from the core account database, and the resource transfer value in the service transaction, for example, a to-be-transferred-out digital resource 5 illustrated in FIG. 4, is obtained. Further, the service server compares the resource transfer value with the current digital resource. If the current digital resource is equal to or greater than the resource transfer value, for example, the resource transfer value is 5 and the current digital resource is 10, the service transaction is performed in the core account layer. That is, resource transfer processing is performed on the to-be-transferred digital resource in the current data resource, to obtain an updated digital resource, for example, (10-5) illustrated.

Further, the service server associatively stores the first moment, the updated digital resource, and the transaction data that carries the data signature in the core account database. To achieve beneficial effects produced in this application, three fields are added to the design of the core account database, which are respectively a transaction authorization start time (i.e., the second moment), a transaction authorization end time (i.e., the latest moment of the transaction verification time range), and a data signature. Referring to Table 1 together, Table 1 is a schematic table of key fields included in an optimized core account database according to an embodiment of this application. Details are shown in Table 1:

TABLE 1

Service account
Transaction type
Transaction amount
Account balance
Transaction recording time
Transaction authorization start time
Transaction authorization end time
Data signature
Database signature

The transaction type in Table 1 in this embodiment of this application includes, but is not limited to, deduction and transfer-out. The transaction amount refers to the resource transfer value in the service transaction. The account balance refers to an updated digital resource. The transaction recording time refers to the first moment. The transaction authorization start time refers to the second moment. The transaction authorization end time refers to a sum of the second moment and an authorization duration, that is, the latest moment in the transaction verification time range. The added data signature field has uniqueness, to prevent duplicate data signatures in the core account database.

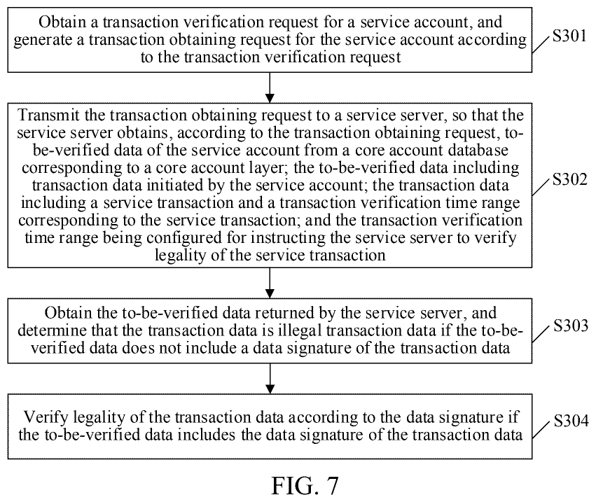

A process in which the verification device verifies legality of the transaction data is not described in detail in this embodiment of this application, which may be obtained with reference to the following description in the embodiment corresponding to FIG. 7.

In this technical solution, an authorization behavior of the service object is sunk to the core account layer by using a cryptography means, an accounting behavior of resource reduction (that is, transfer-out of a digital resource) of the core account layer only recognizes authorization of the service object and does not need to trust an accounting instruction transmitted by a transaction layer of a service institution (i.e., the service server), and the core account layer cannot forge a digital resource transfer-out transaction record without the authorization of the service object, thereby avoiding defects existing in a system in the institution, and also avoiding service account resource loss caused by an malicious action of an illegal person. In terms of post-audit, service transactions of transfer-out of digital resources of the service account are in one-to-one correspondence to data signatures authorized by service objects in the core account database, so as to shorten an evidencing chain, thereby improving audit efficiency and credibility.

In this embodiment of this application, a service server transmits, at a first moment, transaction data initiated by a service account to a core account layer; the transaction data includes a service transaction and a transaction verification time range corresponding to the service transaction, and the transaction data carries a data signature; in the core account layer, the service server may perform signature verification processing on the data signature, to obtain a signature verification result, and if the signature verification result is a signature verification success result, perform legality verification on the service transaction according to the first moment and the transaction verification time range, to obtain a verification result; further, if the verification result indicates that the service transaction is legal, the service server associatively stores the first moment and the transaction data that carries the data signature in a core account database corresponding to the core account layer; the data signature and the transaction data that are stored in the core account database are both configured for being transmitted to a verification device; and the verification device is configured to verify legality of the transaction data according to the data signature. As can be seen from the above, the service server directly transmits the transaction data carrying the data signature to the core account layer, and verifies, in the core account layer, legality of the service transaction by using the data signature and the transaction verification time range. Therefore, in a scenario in which a service account is not authorized, the core account layer may not approve the service transaction and then may not execute the service transaction. Therefore, security of the service account can be improved. In addition, the verification device may verify legality of the transaction data by using the data signature, thereby improving verification efficiency and accuracy of the transaction data.

Referring to FIG. 5, FIG. 5 is a schematic another flowchart of a data processing method according to an embodiment of this application. The method may be performed by a service server (e.g., the service server 100 shown in FIG. 1), may be performed by a service terminal (that is, the terminal device 101a shown in FIG. 1), may be performed by a verification device (e.g., the verification device 102a shown in FIG. 1), or may be interactively performed by at least two of the service server, the terminal device, and the verification device, which is not limited herein. For ease of understanding, this embodiment of this application is described with an example in which the method is interactively performed by the service server and the terminal device. As shown in FIG. 5, the data processing method may include at least operation S201 to operation S206 below.

Operation S201: Obtain, at a third moment earlier than the first moment, a certificate application request initiated by a service terminal; the certificate application request including a service account and a service public key of the service account; and the service public key being generated by the service terminal when applying for the service account.

Specifically, in this embodiment of this application, when applying for a service account, an application client installed on the service terminal (i.e., the terminal device) may synchronously generate a pair of asymmetric keys including a service private key and a service public key. A cryptographic algorithm of the asymmetric keys is not limited in this embodiment of this application, and may be any cryptographic algorithm that generates a public-private key pair.

Further, the service terminal (i.e., the terminal device) generates the certificate application request including the service account and the service public key, and transmits the certificate application request to the service server before generating the service transaction. The third moment at which the service server receives the certificate application request is earlier than the first moment.

Operation S202: Generate a service certificate for the service account according to the certificate application request, and return the service certificate to the service terminal; the service certificate being configured for indicating that the service terminal successfully applies for the service account.

Specifically, the service server verifies the certificate application request, and generates a service certificate for the service account if verifying that the certificate application request is a legal request. The service certificate may indicate that the service terminal successfully applies for the service account. If verifying that the certificate application request is an illegal request, the service server rejects to generate a service certificate for the service account, so as to reject to create the service account for the service object. That is, the service account of the service terminal is an illegal service account.

As can be seen from the above, in this application, the public-private key pair generated by the application client is a necessary condition for opening the service account, and the service public key is sunk to the core account layer of the service information system, that is, stored by the core account database.

In this embodiment of this application, for example, the service server issues the service certificate to the terminal device. In actual application, the terminal device may further transmit the certificate application request to a certificate authority with public trust. A process in which the certificate authority issues a service certificate to the terminal device according to the certificate application request is the same as the foregoing process. Therefore, details are not described herein again.

Operation S203: Associatively store the service public key and the service account in the core account database.

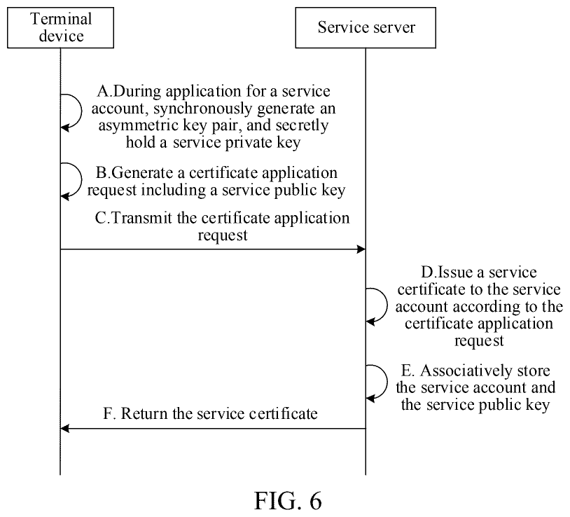

Specifically, referring to FIG. 6 for the foregoing operations, FIG. 6 is a schematic interaction diagram of a data processing method according to an embodiment of this application. As shown in FIG. 6, the data processing method may include at least operation A to operation F below.

Operation A: When applying for a service account, a terminal device synchronously generates an asymmetric key pair, and a service private key is secretly held.

Operation B: The terminal device generates a certificate application request including a service public key.

Operation C: The terminal device transmits the certificate application request to a service server.

Operation D: The service server issues a service certificate to the service account according to the certificate application request.

Operation E: The service server associatively stores the service account and the service public key.

Operation F: The service server returns the service certificate to the terminal device.

An execution sequence of operation F may precede an execution sequence of operation E, the execution sequence of operation F may alternatively follow the execution sequence of operation E, and an execution sequence of operation F may alternatively be synchronous with the execution sequence of operation E.

Operation S204: Transmit, at a first moment, transaction data initiated by the service account to a core account layer; the transaction data including a service transaction and a transaction verification time range corresponding to the service transaction, and the transaction data carrying a data signature.

Operation S205: Perform, in the core account layer, signature verification processing on the data signature, to obtain a signature verification result, and if the signature verification result is a signature verification success result, perform legality verification on the service transaction according to the first moment and the transaction verification time range, to obtain a verification result.

Operation S206: Associatively store, if the verification result indicates that the service transaction is legal, the first moment and the transaction data that carries the data signature in a core account database corresponding to the core account layer; the data signature and the transaction data that are stored in the core account database being both configured for being transmitted to a verification device; and the verification device being configured to verify legality of the transaction data according to the data signature.

Specifically, in this operation, in the core account database, each piece of transaction data has a data signature authorized by a service object, and a service private key corresponding to the data signature is secretly held by the service object. The data signature cannot be forged even within the service system. At the same time, the transaction data in this embodiment of this application includes a transaction verification time range configured for verifying legality of the transaction data, so as to prevent occurrence of a service transaction change within a time range not expected by the service object. Therefore, security of the service account is improved.

For a specific implementation process of operation S204 to operation S206, refer to operation S101 to operation S103 in the embodiment corresponding to FIG. 2. Details are not described herein again.

In this embodiment of this application, a service server transmits, at a first moment, transaction data initiated by a service account to a core account layer; the transaction data includes a service transaction and a transaction verification time range corresponding to the service transaction, and the transaction data carries a data signature; in the core account layer, the service server may perform signature verification processing on the data signature, to obtain a signature verification result, and if the signature verification result is a signature verification success result, perform legality verification on the service transaction according to the first moment and the transaction verification time range, to obtain a verification result; further, if the verification result indicates that the service transaction is legal, the service server associatively stores the first moment and the transaction data that carries the data signature in a core account database corresponding to the core account layer; the data signature and the transaction data that are stored in the core account database are both configured for being transmitted to a verification device; and the verification device is configured to verify legality of the transaction data according to the data signature. As can be seen from the above, the service server directly transmits the transaction data carrying the data signature to the core account layer, and verifies, in the core account layer, legality of the service transaction by using the data signature and the transaction verification time range. Therefore, in a scenario in which a service account is not authorized, the core account layer may not approve the service transaction and then may not execute the service transaction. Therefore, security of the service account can be improved. In addition, the verification device may verify legality of the transaction data by using the data signature, thereby improving verification efficiency and accuracy of the transaction data.

Further, referring to FIG. 7, FIG. 7 is a schematic another flowchart of a data processing method according to an embodiment of this application. The data processing method may be performed by a service server (e.g., the service server 100 shown in FIG. 1), may be performed by a terminal device (that is, a service terminal such as the terminal device 101a shown in FIG. 1), may be performed by a verification device (e.g., the verification device 102a shown in FIG. 1), or may be interactively performed by at least two of the service server, the terminal device, and the verification device, which is not limited herein. For ease of understanding, this embodiment of this application is described with an example in which the method is performed by the verification device. As shown in FIG. 7, the data processing method may include at least operation S301 to operation S304 below.

Operation S301: Obtain a transaction verification request for a service account, and generate a transaction obtaining request for the service account according to the transaction verification request.

Specifically, a device initiating the transaction verification request is not limited in this embodiment of this application. A service terminal bound to the service account may initiate the transaction verification request. For example, when having doubts about a service transaction, the service object may transmit the transaction verification request for the service account to the verification device by using the service terminal. Alternatively, a verification object may initiate the transaction verification request. For example, when the verification object regularly queries service data stored in the core account database by the service server, the transaction verification request for the service account may be generated by using the verification device.

Further, the verification device generates a transaction obtaining request for the service account according to the transaction verification request.

Operation S302: Transmit the transaction obtaining request to a service server, so that the service server obtains, according to the transaction obtaining request, to-be-verified data (also referred to as “target data”) of the service account from a core account database corresponding to a core account layer; the to-be-verified data including transaction data initiated by the service account; the transaction data including a service transaction and a transaction verification time range corresponding to the service transaction; and the transaction verification time range being configured for instructing the service server to verify legality of the service transaction.

Specifically, a quantity of the to-be-verified data is not limited in this embodiment of this application, which may be one or more and may be set according to an actual application scenario. For example, taking the service account as a dimension, the service server may determine all transaction data associatively stored with the service account in the core account database as the to-be-verified data. In another example, taking the transaction recording time (i.e., the first moment) as a dimension, the service server may determine transaction data in the core account database at the first moment as the to-be-verified data.

Operation S303: Obtain the to-be-verified data returned by the service server, and determine that the transaction data is illegal transaction data if the to-be-verified data does not include a data signature of the transaction data.

Specifically, during the post-audit, the verification device may determine legality of transfer-out of the digital resource of the service account only by checking the transaction data in the core account database. When the digital resource transfer-out transaction record does not have a data signature authorized by the service object or verification of the data signature fails, the verification device may determine that the transaction is a transaction not authorized by the service object.

Operation S304: Verify legality of the transaction data according to the data signature if the to-be-verified data includes the data signature of the transaction data.

Specifically, a first service public key of the service account is obtained from the to-be-verified data, and a second service public key is obtained; the second service public key is a service public key provided by a service terminal bound to the service account, or a service public key obtained from a blockchain and having a binding relationship with the service account; the first service public key is compared with the second service public key, to obtain a comparison result; it is determined that the transaction data is illegal transaction data if the comparison result indicates that the first service public key is different from the second service public key; if the comparison result indicates that the first service public key is the same as the second service public key, signature verification processing is performed on the transaction signature according to the first service public key, to obtain a signature verification result; it is determined that the transaction data is illegal transaction data if the signature verification result is a signature verification failure result; and it is determined that the transaction data is legal transaction data if the signature verification result is a signature verification success result.

The first service public key is equivalent to the service public key in the embodiment corresponding to FIG. 2, that is, a service public key associatively stored with the service account in the core account database. Therefore, the verification device regards the first service public key as a to-be-verified public key. The second service public key may be provided by a service device (i.e., the terminal device) bound to the service account, or may be obtained from the blockchain network when the terminal device stores a legal service public key that is generated when the terminal device applies for the service account in the blockchain network.

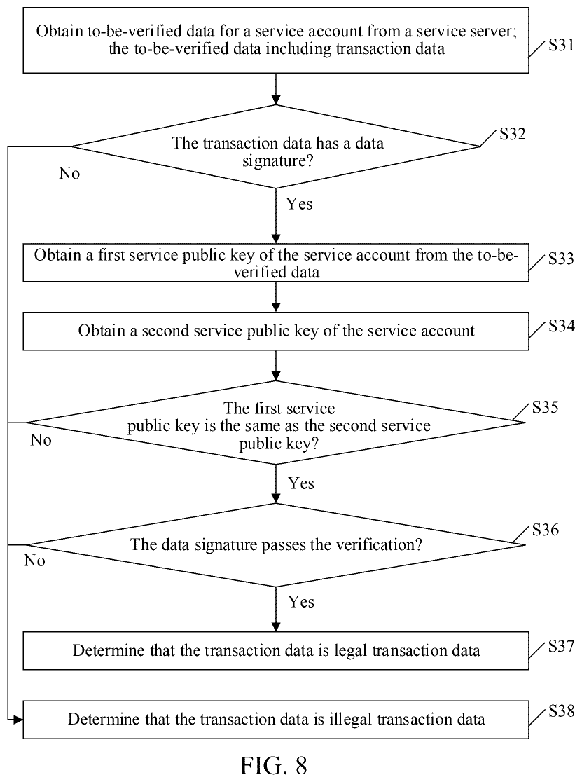

Referring to FIG. 8 for the foregoing process, FIG. 8 is a schematic another flowchart of a data processing method according to an embodiment of this application. As shown in FIG. 8, the data processing method includes the following operations.

Operation S31: Obtain to-be-verified data for a service account from a service server; the to-be-verified data including transaction data.

Operation S32: determine whether the transaction data has a data signature. The verification device checks whether the transaction data has a data signature. If the transaction data carries the data signature, operation S33 is performed. If the transaction data does not carry the data signature, the verification device performs operation S38.

Operation S33: Obtain a first service public key of the service account from the to-be-verified data.

Operation S34: Obtain a second service public key of the service account.

Operation S35: Determine whether the first service public key is the same as the second service public key. The verification device checks whether the first service public key is the same as the second service public key, and performs operation S36 if yes. If the first service public key is different from the second service public key, the verification device performs operation S38.

Operation S36: Determine whether the data signature passes the verification. The verification device performs signature verification processing on the data signature, to obtain a signature verification result. If the signature verification result is a signature verification success result, operation S37 is performed. If the signature verification result is a signature verification failure result, the verification device performs operation S38.

Operation S37: Determine that the transaction data is legal transaction data.

Operation S38: Determine that the transaction data is illegal transaction data.

To strengthen security of the service account in the service information system and security of the digital resource in the service account, this application provides a zero-trust-based service account design method. According to the method, a conventional service account design is optimized from three aspects: account application, transaction recording, and post-audit, and authorization of transfer of the digital resource of the service account out of the service object is combined in a cryptography manner, so as to avoid a problem of illegal transfer-out of the digital resource in the service account that may be caused inside the service institution. In addition, the verification device may verify legality of the transaction data by using the data signature, thereby improving verification efficiency and accuracy of the transaction data.

Further, referring to FIG. 9, FIG. 9 is another schematic flowchart of a data processing method according to an embodiment of this application. The method may be performed by a service server (e.g., the service server 100 shown in FIG. 1), may be performed by a service terminal (that is, the terminal device 101a shown in FIG. 1), may be performed by a verification device (e.g., the verification device 102a shown in FIG. 1), or may be interactively performed by at least two of the service server, the terminal device, and the verification device, which is not limited herein. For ease of understanding, this embodiment of this application is described with an example in which the method is performed by the terminal device. As shown in FIG. 9, the data processing method may include at least operation S401 to operation S403 below.

Operation S401: Determine, in a service account in response to a completion operation on a service transaction, a transaction verification time range configured for verifying legality of the service transaction.

Specifically, a second moment at which a completion operation on the service transaction is responded to is determined as an earliest moment; a transaction verification time threshold is obtained, and the earliest moment and the transaction verification time threshold are summed to obtain a latest moment; and the transaction verification time range including the earliest moment and the latest moment is generated.

The transaction verification time threshold may be adjusted according to a requirement of an actual application scenario. The transaction verification time threshold is illustrated with 2 minutes in FIG. 3.

Operation S402: Generate a data signature of the transaction data; the transaction data including the service transaction and the transaction verification time range.

Specifically, a service private key and a service public key are generated during application for a service account; a certificate application request including the service account and the service public key is generated, and the certificate application request is transmitted to the service server, so that the service server generates a service certificate for the service account according to the certificate application request; the service certificate returned by the service server is obtained; and the service certificate is configured for indicating that the service terminal successfully applies for the service account.

Specifically, the transaction data including the service transaction and the transaction verification time range is generated; and the service private key is obtained, and signature processing is performed on the transaction data by using the service private key, to obtain the data signature of the transaction data.

Referring to FIG. 3 again, the terminal device 101a generates transaction data 30b including a service transaction (including a service account and a to-be-transferred-out digital resource) and a transaction verification time range. The terminal device 101a obtains a service private key 30c stored privately, and performs signature processing on the transaction data 30b by using the service private key 30c, to obtain a data signature 30d of the transaction data 30b.

In this operation, the asymmetric public-private key pair generated by the application client is a necessary condition for opening an account, and the service public key of the application client needs to be sunk to the core account layer of the service information system.

Operation S403: Transmit the transaction data carrying the data signature to a service server by using the service account, so that the service server transmits, at a first moment, the transaction data carrying the data signature to a core account layer; the core account layer being configured to perform signature verification processing on the data signature, to obtain a signature verification result; the signature verification result including a signature verification success result; the signature verification result being configured for instructing the core account layer to perform legality verification on the service transaction according to the first moment and the transaction verification time range, to obtain a verification result; the verification result including a verification result indicating legality; the verification result indicating legality being configured for instructing the core account layer to associatively store the first moment and the transaction data that carries the data signature in a core account database; the data signature and the transaction data that are stored in the core account database being both configured for being transmitted to a verification device; and the verification device being configured to verify legality of the transaction data according to the data signature.

Specifically, in this operation, in the core account database, each piece of transaction data has a data signature authorized by a service object, and a service private key corresponding to the data signature is secretly held by the service object. The data signature cannot be forged even within the service system. In addition, in this application, an authorization time range of transaction verification is added to the transaction data of the data signature, to prevent occurrence of a transaction change of the service account within a time range not expected by the service object, thereby improving security of the transaction data and the service account.

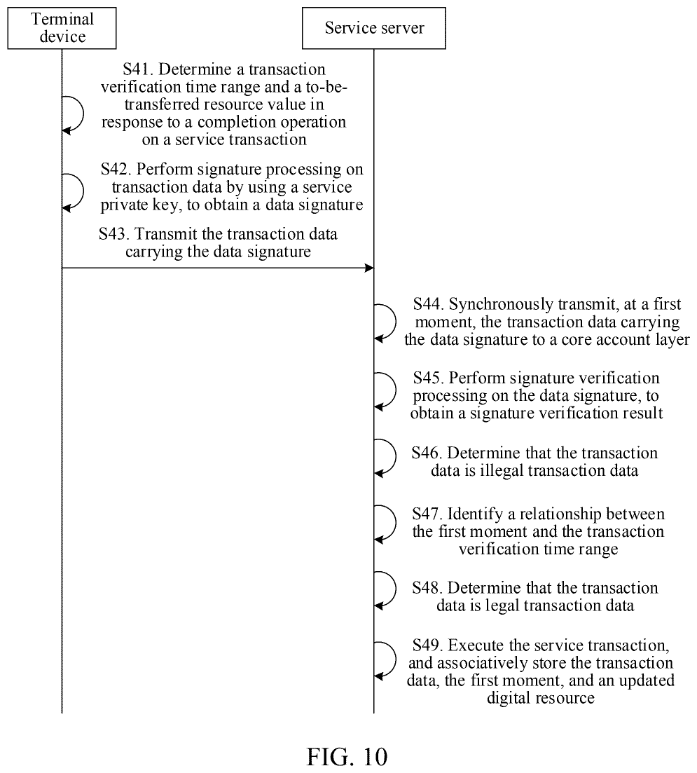

Referring to FIG. 10 for the foregoing process, FIG. 10 is another schematic interaction diagram of a data processing method according to an embodiment of this application. As shown in FIG. 10, the data processing method includes the following operations.

Operation S41: A terminal device determines a transaction verification time range and a to-be-transferred resource value in response to a completion operation on a service transaction.

Operation S42: The terminal device performs signature processing on transaction data by using a service private key, to obtain a data signature.

Operation S43: The terminal device transmits the transaction data carrying the data signature to the service server.

Operation S44: The service server synchronously transmits, at a first moment, the transaction data carrying the data signature to a core account layer; and the service server receives the transaction data carrying the data signature and transmitted by the terminal device at the first moment, and then synchronizes the transaction data to the core account layer.

Operation S45: The service server performs signature verification processing on the data signature, to obtain a signature verification result. The service server performs operation S46 if the signature verification result is a signature verification failure result, and performs operation S47 f the signature verification result is a signature verification success result.

Operation S46: The service server determines that the transaction data is illegal transaction data.

Operation S47: The service server identifies a relationship between the first moment and the transaction verification time range. The service server performs operation S48 if the first moment is within the transaction verification time range, and performs operation S46 if the first moment is later than a latest moment in the transaction verification time range.

Operation S48: The service server determines that the transaction data is legal transaction data.

Operation S49: The service server executes the service transaction, and associatively stores the transaction data, the first moment, and an updated digital resource.

As can be seen from the above, the service server directly transmits the transaction data carrying the data signature to the core account layer, and verifies, in the core account layer, legality of the service transaction by using the data signature and the transaction verification time range. Therefore, in a scenario in which a service account is not authorized, the core account layer may not approve the service transaction and then may not execute the service transaction. Therefore, security of the service account can be improved. In addition, the verification device may verify legality of the transaction data by using the data signature, thereby improving verification efficiency and accuracy of the transaction data.

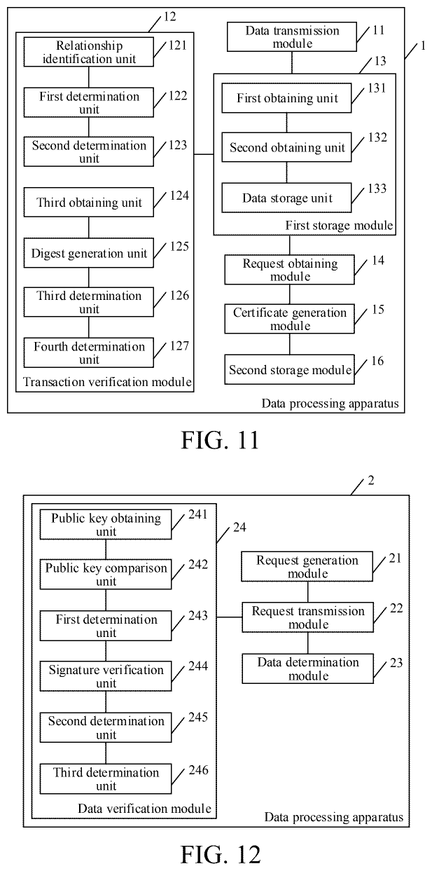

Further, referring to FIG. 11, FIG. 11 is a schematic structural diagram of a data processing apparatus according to an embodiment of this application. The foregoing data processing apparatus 1 may be a computer program (including program code) running in a computer device. For example, the data processing apparatus 1 is application software. Specifically, the data processing apparatus 1 may run on a service server and may be configured to perform the corresponding operations in the method provided in the embodiments of this application. As shown in FIG. 11, the data processing apparatus 1 may include: a data transmission module 11, a transaction verification module 12, and a first storage module 13.

The data transmission module 11 is configured to transmit, at a first moment, transaction data initiated by a service account to a core account layer. The transaction data includes a service transaction and a transaction verification time range corresponding to the service transaction, and the transaction data carries a data signature.

The transaction verification module 12 is configured to perform, in the core account layer, signature verification processing on the data signature, to obtain a signature verification result, and if the signature verification result is a signature verification success result, perform legality verification on the service transaction according to the first moment and the transaction verification time range, to obtain a verification result.

The first storage module 13 is configured to associatively store, if the verification result indicates that the service transaction is legal, the first moment and the transaction data that carries the data signature in a core account database corresponding to the core account layer. The data signature and the transaction data that are stored in the core account database are both configured for being transmitted to a verification device. The verification device is configured to verify legality of the transaction data according to the data signature.

For specific function implementations of the data transmission module 11, the transaction verification module 12, and the first storage module 13, refer to operation S101 to operation S103 in the embodiment corresponding to FIG. 2. Details are not described herein again.

Referring to FIG. 11 again, the transaction verification module 12 may include: a relationship identification unit 121, a first determination unit 122, and a second determination unit 123.

The relationship identification unit 121 is configured to identify a relationship between the first moment and the transaction verification time range. An earliest moment of the transaction verification time range is equal to a second moment at which a service terminal bound to the service account responds to a completion operation on the service transaction. A latest moment of the transaction verification time range is later than the second moment.

The first determination unit 122 is configured to determine, if the relationship between the first moment and the transaction verification time range is that the first moment is within the transaction verification time range, a verification result indicating legality as a verification result of legality verification on the service transaction. The verification result indicating legality is configured for indicating that the service transaction is legal.

The second determination unit 123 is configured to determine, if the relationship between the first moment and the transaction verification time range is that the first moment is later than the latest moment, a verification result indicating illegality as a verification result of legality verification on the service transaction. The verification result indicating illegality is configured for indicating that the service transaction is illegal.

For specific function implementations of the relationship identification unit 121, the first determination unit 122, and the second determination unit 123, refer to operation S102 in the embodiment corresponding to FIG. 2. Details are not described herein again.

Referring to FIG. 11 again, the first storage module 13 may include: a first obtaining unit 131, a second obtaining unit 132, and a data storage unit 133.

The first obtaining unit 131 is configured to obtain a current digital resource of the service account from the core account database corresponding to the core account layer.

The second obtaining unit 132 is configured to obtain a resource transfer value in the service transaction, and if the current digital resource includes a to-be-transferred digital resource corresponding to the resource transfer value, perform resource transfer processing on the to-be-transferred digital resource in the current digital resource, and determine a current digital resource after the resource transfer processing as an updated digital resource.

The data storage unit 133 is configured to associatively store the first moment, the updated digital resource, and the transaction data that carries the data signature in the core account database.

For specific function implementations of the first obtaining unit 131, the second obtaining unit 132, and the data storage unit 133, refer to operation S103 in the embodiment corresponding to FIG. 2. Details are not described herein again.

Referring to FIG. 11 again, the transaction verification module 12 may include: a third obtaining unit 124, a digest generation unit 125, a third determination unit 126, and a fourth determination unit 127.

The third obtaining unit 124 is configured to obtain, in the core account database, a service public key of the service account, and perform signature verification processing on the data signature by using the service public key, to obtain a first digital digest.

The abstract generation unit 125 is configured to generate a second digital digest of the transaction data, and comparing the first digital digest with the second digital digest, to obtain a comparison result.

The third determination unit 126 is configured to determine the signature verification success result as the signature verification result if the comparison result indicates that the first digital digest is the same as the second digital digest. The signature verification success result is further configured for indicating that the data signature is obtained by the service terminal bound to the service account by performing signature processing on the transaction data by using a service private key of the service account.

The fourth determination unit 127 is configured to determine a signature verification failure result as the signature verification result if the comparison result indicates that the first digital digest is different from the second digital digest.

For specific function implementations of the third obtaining unit 124, the digest generation unit 125, the third determination unit 126, and the fourth determination unit 127, refer to operation S102 in the embodiment corresponding to FIG. 2. Details are not described herein again.

Referring to FIG. 11, the data processing apparatus 1 may further include: a request obtaining module 14, a certificate generation module 15, and a second storage module 16.

The request obtaining module 14 is configured to obtain, at a third moment earlier than the first moment, a certificate application request initiated by a service terminal. The certificate application request includes a service account and a service public key of the service account. The service public key is generated by the service terminal when applying for the service account.

The certificate generation module 15 is configured to generate a service certificate for the service account according to the certificate application request, and return the service certificate to the service terminal. The service certificate is configured for indicating that the service terminal successfully applies for the service account.

The second storage module 16 is configured to associatively store the service public key and the service account in the core account database.

For specific function implementations of the request obtaining module 14, the certificate generation module 15, and the second storage module 16, refer to operation S201 to operation S203 in the embodiment corresponding to FIG. 5. Details are not described herein again.

In this embodiment of this application, a service server transmits, at a first moment, transaction data initiated by a service account to a core account layer; the transaction data includes a service transaction and a transaction verification time range corresponding to the service transaction, and the transaction data carries a data signature; in the core account layer, the service server may perform signature verification processing on the data signature, to obtain a signature verification result, and if the signature verification result is a signature verification success result, perform legality verification on the service transaction according to the first moment and the transaction verification time range, to obtain a verification result; further, if the verification result indicates that the service transaction is legal, the service server associatively stores the first moment and the transaction data that carries the data signature in a core account database corresponding to the core account layer; the data signature and the transaction data that are stored in the core account database are both configured for being transmitted to a verification device; and the verification device is configured to verify legality of the transaction data according to the data signature. As can be seen from the above, the service server directly transmits the transaction data carrying the data signature to the core account layer, and verifies, in the core account layer, legality of the service transaction by using the data signature and the transaction verification time range. Therefore, in a scenario in which a service account is not authorized, the core account layer may not approve the service transaction and then may not execute the service transaction. Therefore, security of the service account can be improved. In addition, the verification device may verify legality of the transaction data by using the data signature, thereby improving verification efficiency and accuracy of the transaction data.

Further, referring to FIG. 12, FIG. 12 is another schematic structural diagram of a data processing apparatus according to an embodiment of this application. The foregoing data processing apparatus 2 may be a computer program (including program code) running in a computer device. For example, the data processing apparatus 2 is application software. Specifically, the data processing apparatus 2 may run on a verification device and may be configured to perform the corresponding operations in the method provided in the embodiments of this application. As shown in FIG. 12, the data processing apparatus 2 may include: a request obtaining module 21, a request transmission module 22, a data determination module 23, and a data verification module 24.

The request obtaining module 21 is configured to obtain a transaction verification request for a service account, and generate a transaction obtaining request for the service account according to the transaction verification request.

The request transmission module 22 is configured to transmit the transaction obtaining request to a service server, so that the service server obtains, according to the transaction obtaining request, to-be-verified data of the service account from a core account database corresponding to a core account layer. The to-be-verified data includes transaction data initiated by the service account. The transaction data includes a service transaction and a transaction verification time range corresponding to the service transaction. The transaction verification time range is configured for instructing the service server to verify legality of the service transaction.

The data determination module 23 is configured to obtain the to-be-verified data returned by the service server, and determine that the transaction data is illegal transaction data if the to-be-verified data does not include a data signature of the transaction data.

The data verification module 24 is configured to verify legality of the transaction data according to the data signature if the to-be-verified data includes the data signature of the transaction data.

For specific function implementations of the request obtaining module 21, the request transmission module 22, the data determination module 23, and the data verification module 24, refer to operation S301 to operation S304 in the embodiment corresponding to FIG. 7. Details are not described herein again.

Referring to FIG. 12 again, the data verification module 24 may include: a public key obtaining unit 241, a public key comparison unit 242, a first determination unit 243, a signature verification unit 244, a second determination unit 245, and a third determination unit 246.

The public key obtaining unit 241 is configured to obtain a first service public key of the service account from the to-be-verified data, and obtain a second service public key. The second service public key is a service public key provided by a service terminal bound to the service account, or a service public key obtained from a blockchain and having a binding relationship with the service account.

The public key comparison unit 242 is configured to compare the first service public key with the second service public key, to obtain a comparison result.

The first determination unit 243 is configured to determine that the transaction data is illegal transaction data if the comparison result indicates that the first service public key is different from the second service public key.

The signature verification unit 244 is configured to perform, if the comparison result indicates that the first service public key is the same as the second service public key, signature verification processing on the transaction signature according to the first service public key, to obtain a signature verification result.

The second determination unit 245 is configured to determine that the transaction data is illegal transaction data if the signature verification result is a signature verification failure result.

The third determination unit 246 is configured to determine that the transaction data is legal transaction data if the signature verification result is a signature verification success result.

For specific function implementations of the public key obtaining unit 241, the public key comparison unit 242, the first determination unit 243, the signature verification unit 244, the second determination unit 245, and the third determination unit 246, refer to operation S304 in the embodiment corresponding to FIG. 7. Details are not described herein again.

In this embodiment of this application, a service server transmits, at a first moment, transaction data initiated by a service account to a core account layer; the transaction data includes a service transaction and a transaction verification time range corresponding to the service transaction, and the transaction data carries a data signature; in the core account layer, the service server may perform signature verification processing on the data signature, to obtain a signature verification result, and if the signature verification result is a signature verification success result, perform legality verification on the service transaction according to the first moment and the transaction verification time range, to obtain a verification result; further, if the verification result indicates that the service transaction is legal, the service server associatively stores the first moment and the transaction data that carries the data signature in a core account database corresponding to the core account layer; the data signature and the transaction data that are stored in the core account database are both configured for being transmitted to a verification device; and the verification device is configured to verify legality of the transaction data according to the data signature. As can be seen from the above, the service server directly transmits the transaction data carrying the data signature to the core account layer, and verifies, in the core account layer, legality of the service transaction by using the data signature and the transaction verification time range. Therefore, in a scenario in which a service account is not authorized, the core account layer may not approve the service transaction and then may not execute the service transaction. Therefore, security of the service account can be improved. In addition, the verification device may verify legality of the transaction data by using the data signature, thereby improving verification efficiency and accuracy of the transaction data.

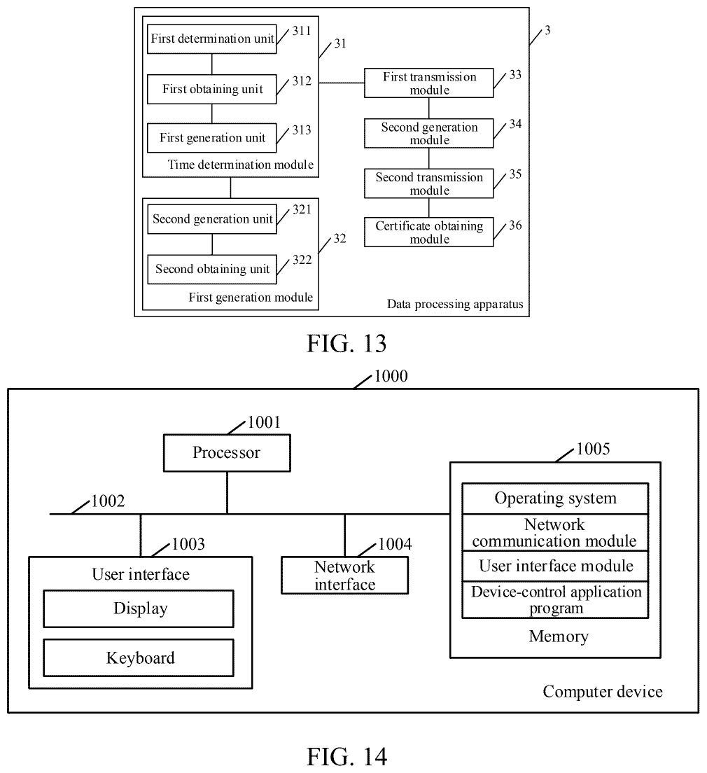

Further, referring to FIG. 13, FIG. 13 is another schematic structural diagram of a data processing apparatus according to an embodiment of this application. The foregoing data processing apparatus 3 may be a computer program (including program code) running in a computer device. For example, the data processing apparatus 3 is application software. Specifically, the data processing apparatus 3 may run on a service terminal and may be configured to perform the corresponding operations in the method provided in the embodiments of this application. As shown in FIG. 13, the data processing apparatus 3 may include a time determination unit 31, a first generation module 32, and a first transmission module 33.

The time determination unit 31 is configured to determine, in a service account in response to a completion operation on a service transaction, a transaction verification time range configured for verifying legality of the service transaction.

The first generation module 32 is configured to generate a data signature of the transaction data. The transaction data includes the service transaction and the transaction verification time range.

The first transmission module 33 is configured to transmit the transaction data carrying the data signature to a service server by using the service account, so that the service server transmits, at a first moment, the transaction data carrying the data signature to a core account layer. The core account layer is configured to perform signature verification processing on the data signature, to obtain a signature verification result. The signature verification result includes a signature verification success result. The signature verification result is configured for instructing the core account layer to perform legality verification on the service transaction according to the first moment and the transaction verification time range, to obtain a verification result. The verification result includes a verification result indicating legality. The verification result indicating legality is configured for instructing the core account layer to associatively store the first moment and the transaction data that carries the data signature in a core account database. The data signature and the transaction data that are stored in the core account database are both configured for being transmitted to a verification device. The verification device is configured to verify legality of the transaction data according to the data signature.

For specific function implementations of the time determination unit 31, the first generation module 32, and the first transmission module 33, refer to operation S401 to operation S403 in the embodiment corresponding to FIG. 9. Details are not described herein again.

Referring to FIG. 13 again, the time determination module 31 may include: a first determination unit 311, a first obtaining unit 312, and a first generation unit 313.

The first determination unit 311 is configured to determine a second moment at which a completion operation on the service transaction is responded to as an earliest moment.

The first obtaining unit 312 is configured to obtain a transaction verification time threshold, and sum the earliest moment and the transaction verification time threshold, to obtain a latest moment.

The first generation unit 313 is configured to generate the transaction verification time range including the earliest moment and the latest moment.

For specific function implementations of the first determination unit 311, the first obtaining unit 312, and the first generation unit 313, refer to operation S401 in the embodiment corresponding to FIG. 9. Details are not described herein again.

Referring to FIG. 13, the data processing apparatus 3 may further include: a second generation module 34, a second transmission module 35, and a certificate obtaining module 36.

The second generation module 34 is configured to generate a service private key and a service public key during application for a service account.

The second transmission module 35 is configured to generate a certificate application request including the service account and the service public key, and transmit the certificate application request to the service server, so that the service server generates a service certificate for the service account according to the certificate application request.

The certificate obtaining module 36 is configured to obtain the service certificate returned by the service server. The service certificate is configured for indicating that the service terminal successfully applies for the service account.

The first generation module 32 may include: a second generation unit 321 and a second obtaining unit 322.

The second generation unit 321 is configured to generate the transaction data including the service transaction and the transaction verification time range.

The second obtaining unit 322 is configured to obtain the service private key, and perform signature processing on the transaction data by using the service private key, to obtain the data signature of the transaction data.

For specific function implementations of the second generation module 34, the second transmission module 35, the certificate obtaining module 36, the second generation unit 321, and the second obtaining unit 322, refer to operation S402 in the embodiment corresponding to FIG. 9. Details are not described herein again.

In this embodiment of this application, a service server transmits, at a first moment, transaction data initiated by a service account to a core account layer; the transaction data includes a service transaction and a transaction verification time range corresponding to the service transaction, and the transaction data carries a data signature; in the core account layer, the service server may perform signature verification processing on the data signature, to obtain a signature verification result, and if the signature verification result is a signature verification success result, perform legality verification on the service transaction according to the first moment and the transaction verification time range, to obtain a verification result; further, if the verification result indicates that the service transaction is legal, the service server associatively stores the first moment and the transaction data that carries the data signature in a core account database corresponding to the core account layer; the data signature and the transaction data that are stored in the core account database are both configured for being transmitted to a verification device; and the verification device is configured to verify legality of the transaction data according to the data signature. As can be seen from the above, the service server directly transmits the transaction data carrying the data signature to the core account layer, and verifies, in the core account layer, legality of the service transaction by using the data signature and the transaction verification time range. Therefore, in a scenario in which a service account is not authorized, the core account layer may not approve the service transaction and then may not execute the service transaction. Therefore, security of the service account can be improved. In addition, the verification device may verify legality of the transaction data by using the data signature, thereby improving verification efficiency and accuracy of the transaction data.

In the embodiment of this application, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

Further, referring to FIG. 14, FIG. 14 is a schematic structural diagram of a computer device according to an embodiment of this application. As shown in FIG. 14, the computer device 1000 may include: at least one processor 1001, e.g., a CPU, at least one network interface 1004, a user interface 1003, a memory 1005, and at least one communication bus 1002. The communications bus 1002 is configured to implement connection and communication between the components. In some embodiments, the user interface 1003 may include a display and a keyboard. In some embodiments, the network interface 1004 may include a standard wired interface and a standard wireless interface (such as a Wi-Fi interface). The memory 1005 may be a high-speed RAM memory, or may be a non-volatile memory, for example, at least one magnetic disk memory. In some embodiments, the memory 1005 may be at least one storage apparatus located remotely from the foregoing processor 1001. As shown in FIG. 14, the memory 1005 used as a computer storage medium may include an operating system, a network communication module, a user interface module, and a device-control application program.

In the computer device 1000 shown in FIG. 14, the network interface 1004 may provide a network communication function. The user interface 1003 is mainly configured to provide an input interface for a user. The processor 1001 may be configured to invoke the device-control application program stored in the memory 1005 to implement:
transmitting, at a first moment, transaction data initiated by a service account to a core account layer; the transaction data including a service transaction and a transaction verification time range corresponding to the service transaction, and the transaction data carrying a data signature;
performing, in the core account layer, signature verification processing on the data signature, to obtain a signature verification result, and if the signature verification result is a signature verification success result, performing legality verification on the service transaction according to the first moment and the transaction verification time range, to obtain a verification result; and
associatively storing, if the verification result indicates that the service transaction is legal, the first moment and the transaction data that carries the data signature in a core account database corresponding to the core account layer; the data signature and the transaction data that are stored in the core account database being both configured for being transmitted to a verification device; and the verification device being configured to verify legality of the transaction data according to the data signature.

Alternatively, the processor 1001 may be configured to invoke the device-control application program stored in the memory 1005 to implement:
obtaining a transaction verification request for a service account, and generating a transaction obtaining request for the service account according to the transaction verification request;
transmitting the transaction obtaining request to a service server, so that the service server obtains, according to the transaction obtaining request, to-be-verified data of the service account from a core account database corresponding to a core account layer; the to-be-verified data including transaction data initiated by the service account; the transaction data including a service transaction and a transaction verification time range corresponding to the service transaction; the transaction verification time range being configured for instructing the service server to verify legality of the service transaction;
obtaining the to-be-verified data returned by the service server, and determining that the transaction data is illegal transaction data if the to-be-verified data does not include a data signature of the transaction data; and
verifying legality of the transaction data according to the data signature if the to-be-verified data includes the data signature of the transaction data.

Alternatively, the processor 1001 may be configured to invoke the device-control application program stored in the memory 1005 to implement:
determining, in a service account in response to a completion operation on a service transaction, a transaction verification time range configured for verifying legality of the service transaction;
generating a data signature of the transaction data; the transaction data including the service transaction and the transaction verification time range;
transmitting the transaction data carrying the data signature to a service server by using the service account, so that the service server transmits, at a first moment, the transaction data carrying the data signature to a core account layer; the core account layer being configured to perform signature verification processing on the data signature, to obtain a signature verification result; the signature verification result including a signature verification success result; the signature verification result being configured for instructing the core account layer to perform legality verification on the service transaction according to the first moment and the transaction verification time range, to obtain a verification result; the verification result including a verification result indicating legality; the verification result indicating legality being configured for instructing the core account layer to associatively store the first moment and the transaction data that carries the data signature in a core account database; the data signature and the transaction data that are stored in the core account database being both configured for being transmitted to a verification device; and the verification device being configured to verify legality of the transaction data according to the data signature.

The computer device 1000 described in this embodiment of this application may implement the description of the data processing method or apparatus in the foregoing embodiments. Details are not described herein again. In addition, the description of beneficial effects of the same method are not described herein again.

An embodiment of this application further provides a computer-readable storage medium. The computer-readable storage medium stores a computer program. When the computer program is executed by a processor, the description of the data processing method or apparatus in the foregoing embodiments is implemented. Details are not described herein again. In addition, the description of beneficial effects of the same method are not described herein again.

The foregoing computer-readable storage medium may be the data processing apparatus provided in any one of the foregoing embodiments or an internal storage unit of the foregoing computer device, such as a hard disk or an internal memory of the computer device. The computer-readable storage medium may alternatively be an external storage device of the computer device, such as a plug-in hard disk, a smart media card (SMC), a secure digital (SD) card, or a flash card equipped on the computer device. Further, the computer-readable storage medium may further include both the internal storage unit and the external storage device of the computer device. The computer-readable storage medium is configured to store the computer program and other programs and data that are required by the computer device. The computer-readable storage medium may be further configured to temporarily store data that has been outputted or is to be outputted.

The embodiments of this application further provide a computer program product, including a computer program. The computer program is stored in a computer-readable storage medium. A processor of a computer device reads the computer program from the computer-readable storage medium. The processor executes the computer program, to cause the computer device to perform the description of the data processing method or apparatus in the foregoing embodiments. Details are not described herein again. In addition, the description of beneficial effects of the same method are not described herein again.

The terms “first,” “second,” and the like in the specification of the embodiments of this application, the claims, and the accompanying drawings are intended to distinguish different objects, instead of describing a particular sequence. In addition, the terms “include/comprise” and any variation thereof are intended to cover a non-exclusive inclusion. For example, processes, methods, apparatuses, products, or devices including a series of operations or units are not limited to the listed operations or modules, but instead, include operations or modules not listed in some embodiments, or include other operations or units inherent to these processes, methods, apparatuses, products, or devices in some embodiments.

A person of ordinary skill in the art may realize that, units and algorithm operations of each example described in combination with the disclosed embodiments herein can be implemented by electronic hardware, computer software, or a combination thereof. To clearly describe interchangeability between the hardware and the software, compositions and operations of each example have been generally described based on functions in the foregoing descriptions. Whether the functions are executed in a mode of hardware or software depends on particular applications and design constraint conditions of the technical solutions. A person skilled in the art may use different methods to implement the described functions for each particular application, but such implementation is not to be considered beyond the scope of this application.

The above are merely exemplary embodiments of this application, and certainly are not intended to limit the scope of the claims of this application. Therefore, equivalent variations made in accordance with the claims of this application shall fall within the scope of this application.

What is claimed is:

1. A data processing method, performed by a service server, comprising:
transmitting, at a moment, transaction data initiated by a service account to a core account layer, the transaction data including a service transaction and a transaction verification time range corresponding to the service transaction, and the transaction data carrying a data signature;
performing, in the core account layer, signature verification on the data signature;
performing, in response to the signature verification being successful, legality verification on the service transaction according to the moment and the transaction verification time range; and
associatively storing, in response to the service transaction being legal, the moment and the transaction data in a core account database corresponding to the core account layer.

2. The method according to claim 1, wherein:
the moment is a first moment; and
performing legality verification on the service transaction includes:
identifying a relationship between the first moment and the transaction verification time range, an earliest moment of the transaction verification time range being equal to a second moment at which a service terminal bound to the service account responds to a completion operation on the service transaction, and a latest moment of the transaction verification time range being later than the second moment;
determining, in response to the relationship being that the first moment is within the transaction verification time range, that the service transaction is legal; and
determining, in response to the relationship being that the first moment is later than the latest moment, that the service transaction is illegal.

3. The method according to claim 1, wherein associatively storing the moment and the transaction data includes:
obtaining a current digital resource of the service account from the core account database;
obtaining a resource transfer value in the service transaction;
in response to the current digital resource including a candidate digital resource corresponding to the resource transfer value, performing resource transfer processing on the candidate digital resource, and determining a current digital resource after the resource transfer processing as an updated digital resource; and
associatively storing the moment, the updated digital resource, and the transaction data in the core account database.

4. The method according to claim 1, wherein performing signature verification processing on the data signature includes:
obtaining, in the core account database, a service public key of the service account, and performing signature verification processing on the data signature using the service public key, to obtain a first digital digest;
generating a second digital digest of the transaction data;
determining, in response to the first digital digest being same as the second digital digest, that the signature verification is successful and that the data signature is obtained by a service terminal bound to the service account by performing signature processing on the transaction data using a service private key of the service account; and
determining, in response to the first digital digest being different from the second digital digest, that the signature verification failed.

5. The method according to claim 1, further comprising:
obtaining, before the transaction data is transmitted, a certificate application request initiated by a service terminal, the certificate application request including a service account and a service public key of the service account, and the service public key being generated by the service terminal when applying for the service account;
generating a service certificate for the service account according to the certificate application request, and returning the service certificate to the service terminal, the service certificate indicating that the service terminal successfully applies for the service account; and
associatively storing the service public key and the service account in the core account database.

6. A computer device comprising:
a processor; and
a memory storing a computer program that, when executed by the processor, causes the computer device to perform the method according to claim 1.

7. The computer device according to claim 6, wherein:
the moment is a first moment; and
the computer program, when executed by the processor, further causes the computer device to, when performing legality verification on the service transaction:
identify a relationship between the first moment and the transaction verification time range, an earliest moment of the transaction verification time range being equal to a second moment at which a service terminal bound to the service account responds to a completion operation on the service transaction, and a latest moment of the transaction verification time range being later than the second moment;
determine, in response to the relationship being that the first moment is within the transaction verification time range, that the service transaction is legal; and
determine, in response to the relationship being that the first moment is later than the latest moment, that the service transaction is illegal.

8. The computer device according to claim 6, wherein the computer program, when executed by the processor, further causes the computer device to, when associatively storing the moment and the transaction data:
obtain a current digital resource of the service account from the core account database;
obtain a resource transfer value in the service transaction;
in response to the current digital resource including a candidate digital resource corresponding to the resource transfer value, perform resource transfer processing on the candidate digital resource, and determining a current digital resource after the resource transfer processing as an updated digital resource; and
associatively store the moment, the updated digital resource, and the transaction data in the core account database.

9. The computer device according to claim 6, wherein the computer program, when executed by the processor, further causes the computer device to, when performing signature verification processing on the data signature:
obtain, in the core account database, a service public key of the service account, and performing signature verification processing on the data signature using the service public key, to obtain a first digital digest;
generate a second digital digest of the transaction data;
determine, in response to the first digital digest being same as the second digital digest, that the signature verification is successful and that the data signature is obtained by a service terminal bound to the service account by performing signature processing on the transaction data using a service private key of the service account; and
determine, in response to the first digital digest being different from the second digital digest, that the signature verification failed.

10. The computer device according to claim 6, wherein the computer program, when executed by the processor, further causes the computer device to:
obtain, before the transaction data is transmitted, a certificate application request initiated by a service terminal, the certificate application request including a service account and a service public key of the service account, and the service public key being generated by the service terminal when applying for the service account;
generate a service certificate for the service account according to the certificate application request, and returning the service certificate to the service terminal, the service certificate indicating that the service terminal successfully applies for the service account; and
associatively store the service public key and the service account in the core account database.

11. A non-transitory computer-readable storage medium storing a computer program that, when executed by a processor, causes a computer device having the processor to perform the method according to claim 1.

12. A data processing method, performed by a verification device, comprising:
generating a transaction obtaining request for a service account according to a transaction verification request;
transmitting the transaction obtaining request to a service server, to cause the service server to obtain, according to the transaction obtaining request, target data of the service account from a core account database corresponding to a core account layer, the target data including transaction data initiated by the service account, the transaction data including a service transaction and a transaction verification time range corresponding to the service transaction, and the transaction verification time range being configured for instructing the service server to verify legality of the service transaction;
obtaining the target data returned by the service server;
determining that the transaction data is illegal in response to the target data not including a data signature of the transaction data; and
verifying legality of the transaction data according to the data signature in response to the target data including the data signature.

13. The method according to claim 12, wherein verifying legality of the transaction data includes:
obtaining a first service public key of the service account from the target data;
obtaining a second service public key, the second service public key being provided by a service terminal bound to the service account, or from a blockchain and having a binding relationship with the service account;
determining that the transaction data is illegal in response to the first service public key being different from the second service public key;
performing, in response to the first service public key being same as the second service public key, signature verification processing on the transaction signature according to the first service public key;
determining that the transaction data is illegal in response to the signature verification having failed; and
determining that the transaction data is legal in response to the signature verification being successful.

14. A computer device comprising:
a processor; and
a memory storing a computer program that, when executed by the processor, causes the computer device to perform the method according to claim 12.

15. A non-transitory computer-readable storage medium storing a computer program that, when executed by a processor, causes a computer device having the processor to perform the method according to claim 12.

16. A data processing method, performed by a service terminal, comprising:
determining, in a service account in response to a completion operation on a service transaction, a transaction verification time range configured for verifying legality of the service transaction;
generating a data signature of transaction data, the transaction data including the service transaction and the transaction verification time range; and
transmitting the transaction data carrying the data signature to a service server using the service account, to cause the service server to transmit, at a moment, the transaction data to a core account layer that is configured to perform signature verification processing on the data signature to obtain a signature verification result that includes a signature verification success result, the signature verification result being configured for instructing the core account layer to perform legality verification on the service transaction according to the moment and the transaction verification time range to obtain a verification result that includes a verification result indicating legality, and the verification result indicating legality being configured for instructing the core account layer to associatively store the moment and the transaction data in a core account database for being transmitted to a verification device, for the verification device to verify legality of the transaction data according to the data signature.

17. The method according to claim 16, wherein:
the moment is a first moment; and
determining the transaction verification time range includes:
determining a second moment, at which the completion operation on the service transaction is responded to, as an earliest moment;
obtaining a transaction verification time threshold, and summing the earliest moment and the transaction verification time threshold to obtain a latest moment; and
generating the transaction verification time range including the earliest moment and the latest moment.

18. The method according to claim 16, further comprising:
generating a service private key and a service public key during application for the service account;
generating a certificate application request including the service account and the service public key;
transmitting the certificate application request to the service server, to cause the service server to generate a service certificate for the service account according to the certificate application request; and
obtaining the service certificate returned by the service server, the service certificate indicating that the service terminal successfully applies for the service account;
wherein generating the data signature of the transaction data includes:
generating the transaction data including the service transaction and the transaction verification time range; and
performing signature processing on the transaction data by using the service private key, to obtain the data signature of the transaction data.

19. A computer device comprising:
a processor; and
a memory storing a computer program that, when executed by the processor, causes the computer device to perform the method according to claim 16.

20. A non-transitory computer-readable storage medium storing a computer program that, when executed by a processor, causes a computer device having the processor to perform the method according to claim 16.
